(19) United States
(12) Patent Application Publication
(10) Pub. No.: US 2015/0073813 A1
(43) Pub. Date: Mar. 12, 2015

(54) System and Method for Doctors to Dynamically Measure Physician Influence on Patient Consumerism to Optimize Profitability on Sales of Non Prescription Medically Unnecessary Products and Services

(71) Applicant: Steven M. Hacker, Delray Beach, FL (US)

(72) Inventor: Steven M. Hacker, Delray Beach, FL (US)

(21) Appl. No.: 14/019,642

(22) Filed: Sep. 6, 2013

(51) Int. Cl. G06Q 50/22; G06Q 30/00

(52) U.S. Cl. CPC G06Q 50/22; G06Q 30/00
USPC 705/2

(57) ABSTRACT

The present invention provides a system and method for determining, defining and quantifiably measuring the influence of a physician on patient consumerism, and converting each unit of physician influence into a measurable dollar amount per unit sales and consequently optimizing profitability on non-prescription non-medically necessary products and services. This is novel system and method, as well in the literature as in the patent database. The invention answers the question: “If a physician puts “x” amount of effort to sell products to their patients, then physician will increase per unit sales price by “y” amount and consequently optimize profitability. The system and method contained herein includes a database that utilizes a server and a mobile application to input real time market metrics to dynamically measure physician influence on their patients in terms of their patients' consumerism and purchasing behavior.

### BACKGROUND OF THE INVENTION

The present invention is directed to a system and method for doctors to measure their influence on patients' consumer/purchasing behavior to optimize profitability on sales of non-prescription medically unnecessary products and services. The quantification of physician influence on their patients in terms of dollars and sales on non-prescription non-medically necessary products and services is not currently defined in the literature or patent database. The present invention answers the question: “If a physician puts “x” amount of effort to sell products to their patients, then physician will increase per unit sales price by “y” amount? Consequently the system and method described herein will optimize profitability against efforts and will measure the average per unit change of Effort/Influence of Physician Per unit sold.

For the purposes of this invention, “Patient consumerism” is defined as the purchase of a product or service in or from a doctors office, doctor associated facility or doctor's website. Physicians retail products in their office and this is well known in the art. These products are typically over the counter non-prescription products that are grouped into the categories of cosmeceuticals or nutraceuticals. Physicians have no idea of the impact of their recommendation, their staff's recommendation, or their sales and marketing efforts and how they can influence and affect pricing and profitability of these products. Currently, physicians arbitrarily price these products at 100% mark up from wholesale. Physicians have no way of measuring their sales and marketing efforts nor determining true market value, pricing and cost and thus often do not sell their inventory or lose money in their retailing efforts or charge their patients in excess of true market retail value.

Retailing products such as cosmeceutical and nutraceuticals in a medical office or through a medical practice web site is well known in the art. Retailing through an office is a direct person to person interaction. Retailing through a doctors web site is through web site visitation. Both of these channels require physicians to educate their patients on the benefits and risks associated with each individual Stock Keeping Unit (SKU) or an entire line of products. The educational process is an implied endorsement by the physician and exerts influence on the patient as to whether or not they should purchase said products. Physicians do not have formalized sales and marketing training nor do they have access, resources, capital or time to access traditional retail channel metrics or resources to upload and price each SKU according to market value. Additionally, traditional retail analytics and dynamic pricing is not pertinent to their retail situation and does not take into consideration the impact of physician influence over their patient. This lack of knowledge and resources makes retailing for doctors inefficient, costly, and time consuming. Also, it is unfair to their patients that purchase their products from their doctors at expensive non-market driven prices versus fair market driven prices based upon patient consumerism and purchasing behaviors. Physicians want to price their products and services fairly to their patients but currently do not have a method to quantify the value of their efforts in terms of pricing or in terms of selling to their patients.

Furthermore, physicians do not have the volume of sales, resources, time or capital to procure any current retailing analytics or marketing analytics for traditional retailing. It may be helpful to review other methodologies for determining pricing recommendations and associated functionality such as those disclosed in U.S. patent application Ser. No. 11/604,504 entitled “Method and System for Price Optimization” by Harun Ahmet Kuyumcu et al. filed on Nov. 27, 2006, U.S. patent application Ser. No. 11/825,957 entitled “Method and System for Refining Pricing Recommendations” by Scott Royston et al. filed Jul. 10, 2007, U.S. patent application Ser. No. 11/827,033 entitled “Method and System for Generating Pricing Recommendations” by Scott Royston et al. filed Jul. 10, 2007, and U.S. patent application Ser. No. 12/057,027 entitled “Method and System for Formulating a Mixed Integer Program for Generating Pricing Recommendations” by Scott Royston et al. filed Mar. 27, 2008 which are all hereby incorporated herein in their entirety. However, there are no analytics or prior art available that consider the impact of a physician's influence on their patient in terms of affecting price and sales. Yet there is no question of the influence a physician exerts on their patient in terms of consumerism and this is a focus of ethics and controversy amongst fellow physicians and patient rights advocates. Yet, amidst this controversy, there is no reproducible, measurable or quantifiable effect known in the art. The present embodiment enables the most current and real time opportunity for physicians to measure anonymous physician's influence in aggregate on their patients' consumerism. To perform the data basing functionalities contained herein this present invention, physicians must offer their retail products through mobile applications. It is expensive to create a mobile application to retail their products, create a SKU and assign an arbitrary price for each SKU, and it is impractical for patients to download a mobile application for every doctor they visit. As a result, physicians do not routinely or easily retail through a mobile application and patients need to either come to the office or visit a website to see and learn about the products their doctor is retailing. Consequently, the doctors current retailing process is overcharging the patient, creating unnecessary burdens for patients to purchase physician recommended products and resulting in loss profitability on the physician side or being overcharged on the patient side.

Furthermore, the creation of current retailing offerings by physicians of different types of products either for sales in their office or on their website is performed manually by the doctors' staff to create an individual SKU for each product and arbitrarily price the product. This is a time consuming arbitrary process with no basis on market driven dynamics and pricing. It results in pricing for consumers that vary based upon physician specialty and geography. For instance, a plastic surgeon may sell the same product at a higher price than the dermatologist in the same town. Or, a dermatologist in New York, for example, may sell the product at a different price than a dermatologist in Florida. Different arbitrary pricing results in an inefficient use of staff, poor inventory management, and, more importantly, over charging of susceptible patients. Additionally, the use of undue influence by a physician towards his patient is controversial amongst physicians and on hand, may be perceived as unethical, unfair or unscrupulous because to date no prior art has quantified the actual dollar impact resulting from physicians influence upon their patients consumerism. The invention contained herein would help both the physician understand the impact of their influence, quantify his efforts by comparing amongst other similar physicians, create a predictable sales and marketing plan for retailing and remove some of the controversy that may create a negative stigma for physicians retailing to their patients. It also will help the patient in terms of paying a price that is more reflective of true costs inclusive of sales and marketing efforts and dynamically driven by true market metrics.

Furthermore, the current mobile retail experience for patients buying physician recommended and dispensed products is time consuming and impractical as it would cause a patient to download a mobile application for every doctor. This is time consuming and impractical as some patients, for example, may have over ten different doctors and would be unlikely to download a single mobile application for each doctor they see. It is also costly for a physician to create a retail mobile application for their practice. Thus, this obstacle needs to be overcome for the purposes of this invention and demonstrating dynamic sales metrics as patients would be unlikely to have the opportunity to purchase retail products recommended by their doctors through a mobile application.

Accordingly, a methodology which overcomes the shortcomings of prior art is desired.

### BRIEF DESCRIPTION OF THE DRAWINGS

The various features of the present invention and the manner of attaining them will be described in greater detail with reference to the following description, claims, drawings, wherein reference numerals are reused, where appropriate to indicate a correspondence between the referenced items, and wherein:

FIG. 1 is a schematic diagram of a system for performing this method in accordance with the invention; and

FIG. 2 is a flow chart illustrating a method of operation for a system of steps for creating, building and maintaining the real time database in accordance with the invention and using the system to quantitatively define the effect of physician influence on patient consumerism and optimizing sales of non-prescription non-medically necessary products to their patient;

### DETAILED DESCRIPTION OF THE PREFERRED EMBODIMENT

The present invention is directed to a system and methodology for doctors to use dynamic market metrics to measure physician influence on patient consumerism to optimize profitability.

The following is the description of the invention:

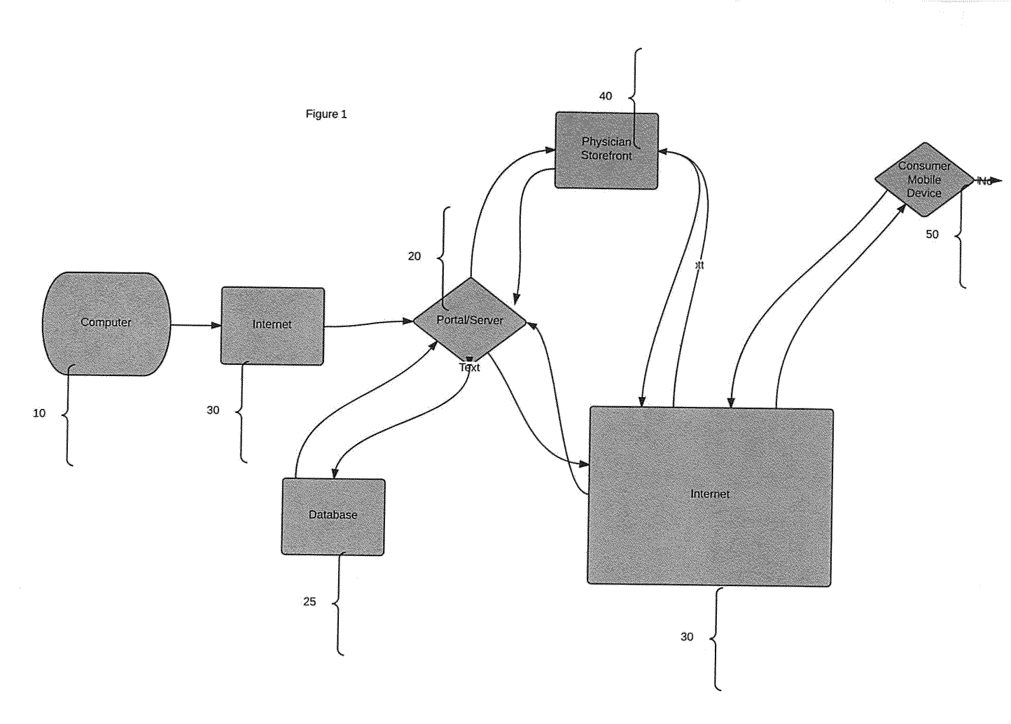

In FIG. 1, Computer 10 is used by physician and is in communication with a server 20 across the internet 30. A database 25 is associated with server 20 for processing, computing and aggregating the following anonymous market metrics: strength of physician influence parameters (PR), price sold, units sold, item (SKU) name, item brand, geography sold, physician specialty, average price sold, highest price sold, and lowest price sold for each item (SKU). Server 20 is also in communication with physician storefront 40 used by consumer to purchase product. Physician storefront 40 is accessed by consumer's mobile device 50.

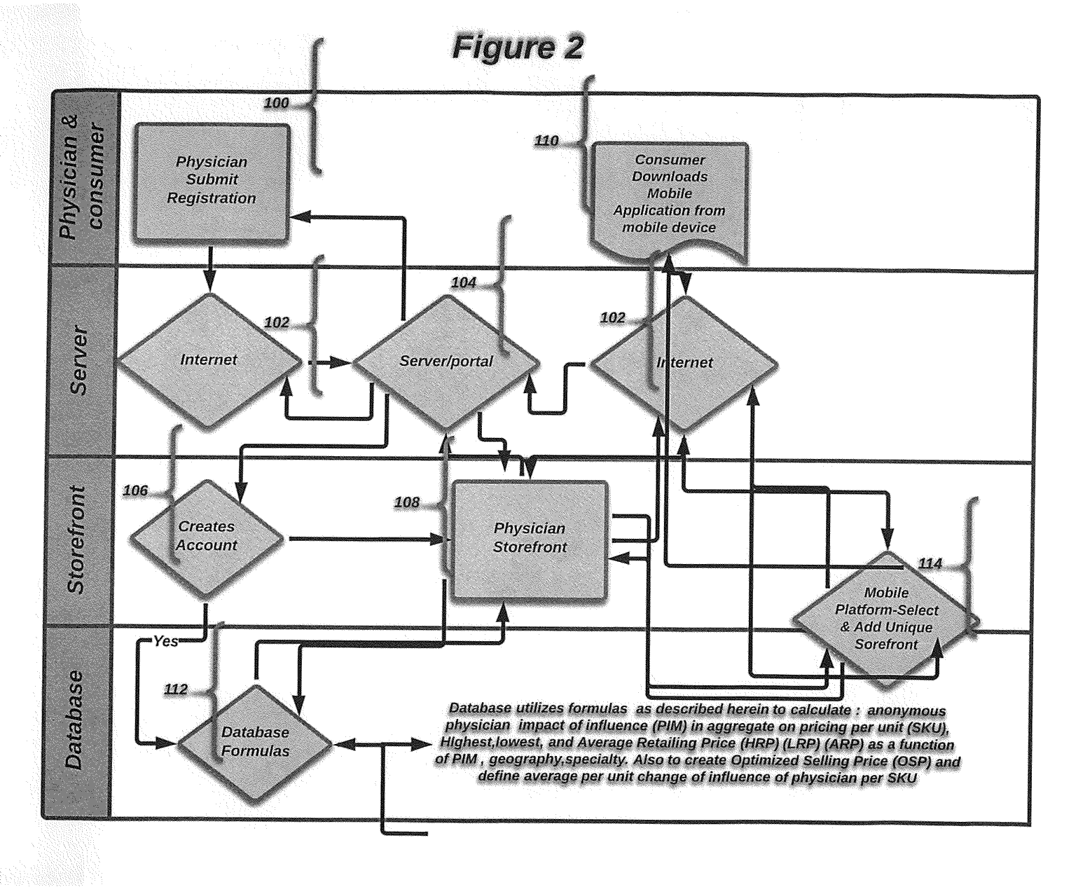

In FIG. 2, step 102, Physician computer 10 communicates with server 20 over the Internet 30 to submit registration, create username and password. In step 104, Physician computer 10 logs into server 20 with usemame and password. In step 106, physician creates his unique storefront on Server 20. Physician adds SKU's of product items by selecting from previously listed images and descriptions of same product items on Server 20, Physician also associates and assigns a PIM to each product SKU based on how physician interacts and influence with his patient in relation to this type of product or sale. Finally, Physician selects fair market pricing options per item based upon pricing metrics from database 25 which aggregates prior physician's PIM with prior sales to present the following options to physician, all of which can be additionally sorted by physician specialty and geography: HRP (Highest Retailing Price) as a function of PIM, LRP (Lowest Retailing Price) as a function of PIM ARP (Average Retailing Price) as a function of PIM, OSP (Optimized Selling Price) and PI (Per unit Physician Influence measured in dollars). Physician also has the option for dynamic pricing modes and static pricing modes. Dynamic pricing enables the physician to set the system to dynamically automatically update the pricing based on set time intervals at selected pricing tiers such as HRP, LRP, ARP or OSP per SKU. The static pricing mode keeps the price static at the same amount the physician input and does not automatically change until physician changes manually. In step 108, the storefront 40 is made accessible to mobile devices 50 through a mobile application. In step 110, patient downloads one mobile application platform through the Internet 102 and after connecting with server/portal 104. From within mobile platform 110, the patient than searches and finds their own physician's unique storefront 114 from the customized physician storefront platform 108 and adds their own physician's unique storefront to mobile platform 110 to enable access to their physician's unique storefront 108. The patient than purchases products through the unique physician storefront 108 at a price set by their physician. The purchase price, SKU, geography, physician specialty and the associated PIM are recorded, input and associated in database 112 and the formulas in database are implemented to use inputs to calculate HRP, LRP, ARP, and OSP as a function of PIM so that the data base builds sequentially to provide resulting calculations through database 112 back to physician through server portal 104.

The Basic Model The PIM scale is a numerical scale consisting of point attributes from one to five (being the highest) of five different Physician Recommendations (PR) attributable to influencing patient consumerism. The following is the PIM scale.

PIM5

Physician directly recommends product to patient or products are displayed in Exam Room. Products may display in waiting room.

PIM4

Physician staff, not physician, directly recommends product to patient, no products are displayed in exam room. Products may display in waiting room.

PIM3

No direct recommendation to patient but promotional materials sent to patient email, home or given out in office, no products are displayed in exam room. Products may display in waiting room.

PIM2

No direct recommendation to patient, no promotional materials sent to patient, only display materials, marketing collateral in office or on website. No products in display in exam room and no products in display in waiting room.

PIM1

No direct recommendation to patient, no promotional materials sent to patient, no materials or marketing collateral in office, just display of products in front office but no displays in exam room or in waiting room.

The following are definitions of calculations and variables used in creating the database:

US—Defined as Number of Units Sold of any SKU

HRP—Highest Retailing Price +/−30% as a function of PIM

LRP—Lowest Retailing Price +/−30% as a function of PIM

ARP—Average Selling Price=(HRPx US)+(LRP×US)/total US

OSP—Optimized Selling Price—Is defined as the most units sold (US) at a certain price point associated with a PIM that also yields the most profit (Retail-Wholesale) per SKU. Database compares within each SKU the total number of units sold at each price point to find the greatest profit to determine the OSP.

PUI—Per Unit Physician Influence change in PIM scale measured in dollars for HRP, LRP and AWP.

PP—# of Physician Participants.

The database 25 aggregates and grows the data metrics sequentially with each additional user in real time and assigns the following formula to calculate outcomes interpreted by physicians.

The formulas below calculate the relative impact of physician influence per unit of influence change on price per unit sold of product (PUI) at certain price points (HRP, LRP, ARP):

((PIM5×US (Number of Units Sold)×HRP (Highest Retail Price)/PP)/US)−((PIM4×US (Number of Units Sold)×HRP (Highest Retail Price)/PP)/US)=relative impact of physician influence on price per unit at HRP. This reflects price change when observing a change from PIM 4 to PIM 5.

((PIM4×US (Number of Units Sold)×HRP (Highest Retail Price)/PP)/US)−((PIM3×US (Number of Units Sold)×HRP (Highest Retail Price)/PPyUS)=relative impact of physician influence on price per unit at HRP. This reflects price change when observing a change from PIM 3 to PIM 4.

((PIM3×US (Number of Units Sold)×HRP (Highest Retail Price)/PP)/US)−((PIM2×US (Number of Units Sold)×HRP (Highest Retail Price)/PP)/US)=relative impact of physician influence on price per unit at HRP. This reflects price change when observing a change from PIM 2 to PIM 3.

((PIM2×US (Number of Units Sold)×HRP (Highest Retail Price)/PP)/US)−((PIM1×US (Number of Units Sold)×HRP (Highest Retail Price)/PP)/US)=relative impact of physician influence on price per unit at HRP. This reflects price change when observing a change from PIM 1 to PIM 2.

((PIM5×US (Number of Units Sold)×LRP (Highest Retail Price)/PP)/US)−((PIM4×US (Number of Units Sold)×LRP (Highest Retail Price)/PP)/US)=relative impact of physician influence on price per unit at LRP This reflects price change when observing a change from PIM 4 to PIM 5.

((PIM4×US (Number of Units Sold)×LRP (Highest Retail Price)/PP)/US)−((PIM3×US (Number of Units Sold)×LRP (Highest Retail Price)/PP)/US)=relative impact of physician influence on price per unit at LRP. This reflects price change when observing a change from PIM 3 to PIM 4.

((PIM3×US (Number of Units Sold)×LRP (Highest Retail Price)/PP)/US)−((PIM2×US (Number of Units Sold)×LRP (Highest Retail Price)/PP)/US)=relative impact of physician influence on price per unit at LRP. This reflects price change when observing a change from PIM 2 to PIM 3.

((PIM2×US (Number of Units Sold)×LRP (Highest Retail Price)/PP/US)−((PIM1×US (Number of Units Sold)×LRP (Highest Retail Price)/PPyUS)=relative impact of physician influence on price per unit at LRP. This reflects price change when observing a change from PIM 1 to PIM 2.

((PIM5×US (Number of Units Sold)×ARP (Highest Retail Price)/PP)/US)−((PIM4×US (Number of Units Sold)×ARP (Highest Retail Price)/PP)/US)=relative impact of physician influence on price per unit at ARP. This reflects price change when observing a change from PIM 4 to PIM 5.

((PIM4×US (Number of Units Sold)×ARP (Highest Retail Price)/PP)/US)−((PIM3×US (Number of Units Sold)×ARP (Highest Retail Price)/PP)/US)=relative impact of physician influence on price per unit at ARP. This reflects price change when observing a change from PIM 3 to PIM 4.

((PIM3×US (Number of Units Sold)×ARP (Highest Retail Price)/PP)/US)−((PIM2×US (Number of Units Sold)×ARP (Highest Retail Price)/PP)/US)=relative impact of physician influence on price per unit at ARP. This reflects price change when observing a change from PIM 2 to PIM 3.

((PIM2×US (Number of Units Sold)×ARP (Highest Retail Price)/PP)/US)−((PIM1×US (Number of Units Sold)×ARP (Highest Retail Price)/PP)/US)=relative impact of physician influence on price per unit at ARP. This reflects price change when observing a change from PIM 1 to PIM 2.

While this invention has been particularly shown and described to reference the preferred embodiments thereof, it would be understood by those skilled in the art that various changes in form and detail may be made therein without departing from the scope of the invention encompassed by the impended claims. Although the embodiments have been described in reference to products such as non-prescription non-medically necessary products with associated SKU's, the system and method according to the embodiments of the present invention may also apply to healthcare services, pharmaceuticals, medical and surgical devices and would not be limited to doctors office, healthcare facilities or doctors websites but may also apply to pharmacies and hospitals and healthcare facilities such as nursing homes. The scope of the invention also extends to various combinations and modifications that may fall within the spirit of the appended claim.

What is claimed as new and desired to be protected by Letters Patent of the United States is:

1. A novel method for defining physician influence on patient consumerism or purchasing behavior for products and services.

2. The method of claim 1, further comprising a numerical scale defined for the purposes of this invention as the Physician Influence Metrics Scale (PIM) and assigns a numerical value of one to five (1 to 5) for five different measurable parameters of influence:
PIM5
Physician directly recommends product to patient or products are displayed in Exam Room. Products may display in waiting room.
PIM4
Physician staff, not physician, directly recommends product to patient; no products are displayed in exam room. Products may display in waiting room.
PIM3
No direct recommendation to patient but promotional materials sent to patient email, home or given out in office, no products are displayed in exam room. Products may display in waiting room.
PIM2
No direct recommendation to patient, no promotional materials sent to patient, only display materials, marketing collateral in office or on website. No products in display in exam room and no products in display in waiting room.
PIM1
No direct recommendation to patient, no promotional materials sent to patient, no materials or marketing collateral in office, just display of products in front office but no displays in exam room or in waiting room.

3. The method of claim 2, further comprising a dynamic database that is populated in real time by physicians associating the numerical value of the defined parameter of influence with a product SKU for sale to their patients.

4. The method of claim 2, further comprising a system of quantifying a physician's influence on patient consumerism in units of influence and dollars per unit sales at certain price points.
The formulas below calculate the relative impact of physician influence per unit of influence change on price per unit sold of product (PUI) at certain price points (HRP, LRP, ARP):
((PIM5×US (Number of Units Sold)×HRP (Highest Retail Price)/PP)/US)−((PIM4×US (Number of Units Sold)×HRP (Highest Retail Price)/PP)/US)=relative impact of physician influence on price per unit at HRP. This reflects price change when observing a change from PIM 4 to PIM 5.
((PIM4×US (Number of Units Sold)×HRP (Highest Retail Price)/PP)/US)−((PIM3×US (Number of Units Sold)×HRP (Highest Retail Price)/PP)/US)=relative impact of physician influence on price per unit at HRP. This reflects price change when observing a change from PIM 3 to PIM 4.
((PIM3×US (Number of Units Sold)×HRP (Highest Retail Price)/PP)/US)−((PIM2×US (Number of Units Sold)×HRP (Highest Retail Price)/PP)/US)=relative impact of physician influence on price per unit at HRP. This reflects price change when observing a change from PIM 2 to PIM 3.
((PIM2×US (Number of Units Sold)×HRP (Highest Retail Price)/PP)/US)−((PIM1×US (Number of Units Sold)×HRP (Highest Retail Price)/PP)/US)=relative impact of physician influence on price per unit at HRP. This reflects price change when observing a change from PIM 1 to PIM 2.
((PIM5×US (Number of Units Sold)×LRP (Highest Retail Price)/PP)/US)−((PIM4×US (Number of Units Sold)×LRP (Highest Retail Price)/PP)/US)=relative impact of physician influence on price per unit at LRP This reflects price change when observing a change from PIM 4 to PIM 5.
((PIM4×US (Number of Units Sold)×LRP (Highest Retail Price)/PP)/US)−((PIM3×US (Number of Units Sold)×LRP (Highest Retail Price)/PP)/US)=relative impact of physician influence on price per unit at LRP. This reflects price change when observing a change from PIM 3 to PIM 4.
((PIM3×US (Number of Units Sold)×LRP (Highest Retail Price)/PP)/US)−((PIM2×US (Number of Units Sold)×LRP (Highest Retail Price)/PP)/US)=relative impact of physician influence on price per unit at LRP. This reflects price change when observing a change from PIM 2 to PIM 3.
((PIM2×US (Number of Units Sold)×LRP (Highest Retail Price)/PP)/US)−((PIM1×US (Number of Units Sold)×LRP (Highest Retail Price)/PP)/US)=relative impact of physician influence on price per unit at LRP. This reflects price change when observing a change from PIM 1 to PIM 2.
((PIM5×US (Number of Units Sold)×ARP (Highest Retail Price)/PP)/US)−((PIM4×US (Number of Units Sold)×ARP (Highest Retail Price)/PP)/US)=relative impact of physician influence on price per unit at ARP. This reflects price change when observing a change from PIM 4 to PIM 5.
((PIM4×US (Number of Units Sold)×ARP (Highest Retail Price)/PP)/US)−((PIM3×US (Number of Units Sold)×ARP (Highest Retail Price)/PP)/US)=relative impact of physician influence on price per unit at ARP. This reflects price change when observing a change from PIM 3 to PIM 4.
((PIM3×US (Number of Units Sold)×ARP (Highest Retail Price)/PP)/US)−((PIM2×US (Number of Units Sold)×ARP (Highest Retail Price)/PP)/US)=relative impact of physician influence on price per unit at ARP. This reflects price change when observing a change from PIM 2 to PIM 3.
((PIM2×US (Number of Units Sold)×ARP (Highest Retail Price)/PPyUS)−((PIM1×US (Number of Units Sold)×ARP (Highest Retail Price)/PP)/US)=relative impact of physician influence on price per unit at ARP. This reflects price change when observing a change from PIM 1 to PIM 2.

5. The method of claim 2, further comprising a system and method to enable physicians to add SKU's at Optimum Sales Price (OSP) where OSP is defined as the most units sold (US) at a certain price point associated with a PIM that also yields the most profit (Retail price-Wholesale price) per SKU. Database compares within each SKU the total number of units sold at each price point to find the greatest profit to determine the OSP.

6. The method of claim 2, further comprising a system and database that aggregates sequentially the experience of other physicians anonymously in terms of their influence on their patient's consumerism as it relates to sales of product SKU's.

7. The method of claim 2, further comprising a system and database that aggregates sequentially the experience of other physicians anonymously in terms of products sales as it relates to physician specialty and geography.

8. The method of claim 2, further comprising a system and method of how physicians may choose to price their products based upon access to highest retail price, lowest retail price, average retail price, and optimum selling price considering physician influence. The formula to determine Average Retail Price (ARP) equals (Highest Retail Price (HRP)×Total number of units sold (US))+(Lowest Retail Price (LRP)×total number of units sold (US)) divided by total number of US at both highest and lowest retail price.

9. A novel method for patients to access more than one physician's mobile storefront application by downloading only one mobile application.

10. The method of claim 8, further comprising a system that associates price paid for product SKU by patient using mobile application and associates that price in a database that is accessible by selling physicians to learn the value of their influence on the sale for future price determinations based upon patient consumerism.

11. The method of claim 8, further comprising a system for physicians to create a retail storefront in a mobile application by selecting from pre-populated SKUs that take into account pricing options based upon PIM, specialty, geography and include OSP and making that storefront available to their patient's mobile devices.

12. A novel method for enabling physicians to set dynamic real time pricing updates based upon anonymous physicians in aggregate PIM at set time intervals and at set price points including Highest Retail Price (HRP), Lowest Retail Price (LRP), Average Retail Price (ARP) and Optimum Sales Price (OSP) all as a function of PIM.

13. A novel method for a physician to determine what precise price change may be assigned to the retail price of a product based upon historical sales of that product as a function of increasing or decreasing their influence on that patient and more specifically as a unit change in the PIM scale.
